(19) United States
(12) Patent Application Publication
(10) Pub. No.: US 2024/0310229 A1
(43) Pub. Date: Sep. 19, 2024

(54) METHOD AND SYSTEM FOR PREDICTING DIFFUSION RANGE OF HAZARDOUS GAS, ELECTRONIC DEVICE AND STORAGE MEDIUM

(71) Applicant: BEIJING INSTITUTE OF TECHNOLOGY, Beijing (CN)

(72) Inventors: Jianwei LI, Beijing (CN); Zhonghao TIAN, Beijing (CN); Xuechao WANG, Beijing (CN); Rongxue KANG, Beijing (CN); Hangyu ZHOU, Beijing (CN); Bo DENG, Beijing (CN)

(21) Appl. No.: 18/473,832

(22) Filed: Sep. 25, 2023

(30) Foreign Application Priority Data
Mar. 13, 2023 (CN) 202310231316.0

(51) Int. Cl. G01M 3/04

(52) U.S. Cl. CPC G01M 3/04

(57) ABSTRACT

A method and system for predicting a diffusion range of a hazardous gas, an electronic device and a storage medium are provided. The method includes: gridding a space area of a public scene to obtain a gridded space; performing leakage source analysis according to the gridded space to determine a leakage feature; determining a hazardous gas prediction manner according to the leakage feature and an early warning condition, where the hazardous gas prediction manner includes a hazardous gas existence mode and a protective gas coexistence mode; determining a diffusion circle coverage according to the hazardous gas prediction manner and a wall barrier action; determining a hazardous gas concentration in grids covered by a diffusion circle according to the diffusion circle coverage; and determining a hazardous gas distribution according to the hazardous gas concentration, a leakage outlet and a ventilation opening.

### CROSS REFERENCE TO RELATED APPLICATION

This patent application claims the benefit and priority of Chinese Patent Application No. 202310231316.0 filed with the China National Intellectual Property Administration on Mar. 13, 2023, the disclosure of which is incorporated by reference herein in its entirety as part of the present application.

### TECHNICAL FIELD

The present disclosure relates to the field of prediction of hazardous gas diffusion, and in particular to a method and system for predicting a diffusion range of a hazardous gas, an electronic device and a storage medium.

### BACKGROUND

In an application place involving a hazardous gas (e.g., hydrogen), it is very important to protect people against potential harm caused by the gas. When the hazardous gas leaks, it often diffuses rapidly in the air and forms a hazardous gas cloud, giving rise to a potential risk of poisoning, combustion or explosion. At present, there is no prediction means for detecting the hazardous gas leakage and diffusion, and the detection is mostly directly carried out by a gas sensor. During the period from the detection of gas leakage to alerting by the sensor, the diffusion of the hazardous gas in space is completely unknown, which is not conductive to the development of subsequent hazardous emergency work. Furthermore, considering that the prediction of hazardous gas diffusion may be used to simulate the leakage and diffusion without a physical object and find out a position and time required for the hazardous gas cloud cluster to gather easily, it plays an important guiding role in the positioning arrangement of sensors and the construction of a hazardous gas emergency treatment system. In addition, the starting of hazardous gas treatment system in many application places still requires manual control by personnel, which brings some uncertain and unsafe factors. Therefore, a gas diffusion prediction method flow that can predict the distribution range of the hazardous gas and can be linked with the hazardous gas treatment system in real time is urgently needed, so as to reduce the risk of accidents caused by the hazardous gas.

### SUMMARY

An objective of embodiments of the present disclosure is to provide a method and system for predicting a diffusion range of a hazardous gas, an electronic device and a storage medium, so as to improve the accuracy of the prediction of the hazardous gas diffusion.

To achieve the above objective, the present disclosure provides the following technical solutions.

The present disclosure provides a method for predicting a diffusion range of a hazardous gas, which includes:
gridding a space area of a public scene to obtain a gridded space;
performing leakage source analysis according to the gridded area to determine a leakage feature;
determining a hazardous gas prediction manner according to the leakage feature and an early warning condition, where the hazardous gas prediction manner includes a hazardous gas existence mode and a protective gas coexistence mode;
determining a diffusion circle coverage according to the hazardous gas prediction manner and a wall barrier action;
determining a hazardous gas concentration in grids covered by a diffusion circle coverage according to the diffusion circle coverage; and
determining a hazardous gas distribution according to the hazardous gas concentration, a leakage outlet and a ventilation opening.

Alternatively, the determining a hazardous gas prediction manner according to the leakage feature and an early warning condition specifically includes:
determining whether the public scene meets the early warning condition to obtain a first determination result, where the early warning condition is that the hazardous gas reaches a security alert or a protective gas valve has been turned on;
if the first determination result is yes, determining that the hazardous gas prediction manner is a protective gas coexistence mode; and
if the first determination result is no, determining that the hazardous gas prediction manner is a hazardous gas existence mode.

Alternatively, the determining a diffusion circle coverage according to the hazardous gas prediction manner and a wall barrier action specifically includes:
determining whether an action with a wall barrier takes place to obtain a second determination result;
if the second determination result is yes, determining the diffusion circle coverage according to the hazardous gas existence mode of the hazardous gas prediction manner and a gas diffusion rule with a barrier; and
if the second determination result is no, determining the diffusion circle coverage according to the hazardous gas existence mode of the hazardous gas prediction manner, a wind velocity, and the gas diffusion rule without a barrier.

Alternatively, the determining the hazardous gas distribution according to the hazardous gas concentration, a leakage outlet and a ventilation opening specifically includes:
determining whether an action with the ventilation opening takes place to obtain a third determination result;
if the third determination result is yes, determining the hazardous gas distribution according to a size and a position of the ventilation opening, the hazardous gas concentration and the leakage outlet; and
if the third determination result is no, determining the hazardous gas distribution according to the hazardous gas concentration and the leakage outlet.

The present disclosure further provides a system for predicting a diffusion range of a hazardous gas, which includes:
a gridding module configured to grid a space area of a public scene to obtain a gridded space;
a leakage source analyzing module configured to perform leakage source analysis according to the gridded space to determine a leakage feature;
a hazardous gas prediction manner determining module configured to determine a hazardous gas prediction manner according to the leakage feature and an early warning condition, where the hazardous gas prediction manner includes a hazardous gas existence mode and a protective gas coexistence mode;
a diffusion circle coverage range determining module configured to determine a diffusion circle coverage according to the hazardous gas prediction manner and a wall barrier action;
a hazardous gas concentration determining module configured to determine a hazardous gas concentration in grids covered by the diffusion circle according to the diffusion circle coverage; and
a gas distribution determining module configured to determine a hazardous gas distribution according to the hazardous gas concentration, a leakage outlet and a ventilation opening.

Alternatively, the hazardous gas prediction manner determining module specifically includes:
an early warning condition determination unit configured to determine whether the public scene meets the early warning condition to obtain a first determination result, where the early warning condition is that the hazardous gas reaches a security alert or a protective gas valve has been turned on;
a protective gas coexistence mode determining unit configured to, if the first determination result is yes, determine that the hazardous gas prediction manner is a protective gas coexistence mode; and
a hazardous gas existence mode determining unit configured to, if the first determination result is no, determine that the hazardous gas prediction manner is a hazardous gas existence mode.

Alternatively, the diffusion circle coverage range determining module may specifically include:
a wall barrier action determining unit configured to determine whether an action with a wall barrier takes place to obtain a second determination result;
a first diffusion circle coverage determining unit configured to, if the second determination result is yes, determine the diffusion circle coverage according to the hazardous gas existence mode of the hazardous gas prediction manner and a gas diffusion rule with a barrier; and
a second diffusion circle coverage determining unit configured to, if the second determination result is no, determine the diffusion circle coverage according to the hazardous gas existence mode of the hazardous gas prediction manner, a wind velocity, and a gas diffusion rule without a barrier.

Alternatively, the distribution determining module specifically includes:
a ventilation opening action determining unit configured to determine whether an action with the ventilation opening takes place to obtain a third determination result;
a first distribution determining unit configured to, if the third determination result is yes, determine the hazardous gas distribution according to a size and a position of the ventilation opening, the hazardous gas concentration and the leakage outlet; and
a second distribution determining unit configured to, if the third determination result is no, determine the hazardous gas distribution according to the hazardous gas concentration and the leakage outlet.

The present disclosure further provides an electronic device, which includes:
one or more processors; and
a storage device storing one or more programs thereon;
where the one or more programs, when executed by the one or more processors, cause the one or more processors to implement the method according to any one of the above items.

The present disclosure further provides a storage medium storing a computer program thereon, where the computer program, implements the method according to any one of the above items.

According to specific embodiments provided by the present disclosure, the present disclosure has the following technical effects.

The method of the present disclosure includes: gridding a space area of a public scene to obtain a gridded space: performing leakage source analysis according to the gridded space to determine a leakage feature: determining a hazardous gas prediction manner according to the leakage feature and an early warning condition, the hazardous gas prediction manner including a hazardous gas existence mode and a protective gas coexistence mode: determining a diffusion circle coverage according to the hazardous gas prediction manner and a wall barrier action; determining a hazardous gas concentration in grids covered by a diffusion circle according to the diffusion circle coverage; and determining a hazardous gas distribution according to the hazardous gas concentration, a leakage opening and a ventilation opening. The accuracy of the prediction of hazardous gas diffusion can be improved by considering the influences of the wall barrier action, the leakage opening and the ventilation opening on hazardous gas diffusion.

### BRIEF DESCRIPTION OF THE DRAWINGS

To describe the technical solutions in the embodiments of the present disclosure or in the prior art more clearly, the accompanying drawings required in the embodiments are briefly described below: Apparently, the accompanying drawings in the following description are merely some embodiments of the present disclosure, and other drawings can be derived from these accompanying drawings by those of ordinary skill in the art without creative efforts.

FIG. 1 is a schematic diagram of processing of a hazardous gas leakage source and a scene.

FIG. 2 is a schematic diagram of a distribution of a hazardous gas cloud cluster.

FIG. 3 is a flowchart of a method for predicting a diffusion range of a hazardous gas in practical use.

FIG. 4 is a diagram illustrating a prediction result of hydrogen diffusion without a protective measure at the 5th second.

FIG. 5 is a diagram illustrating a prediction result of hydrogen diffusion with a protective measure at the 5th second.

FIG. 6 is a flowchart of the method for predicting a diffusion range of a hazardous gas according to the present disclosure.

### DETAILED DESCRIPTION OF THE EMBODIMENTS

The technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts shall fall within the protection scope of the present disclosure.

An objective of embodiments of the present disclosure is to provide a method and system for predicting a diffusion range of a hazardous gas, an electronic device and a storage medium, so as to improve the accuracy of the prediction of the hazardous gas diffusion.

To make the above objective, features, and advantages of the present disclosure clearer and more comprehensible, the present disclosure will be further described in detail below with reference to the accompanying drawings and the specific embodiments.

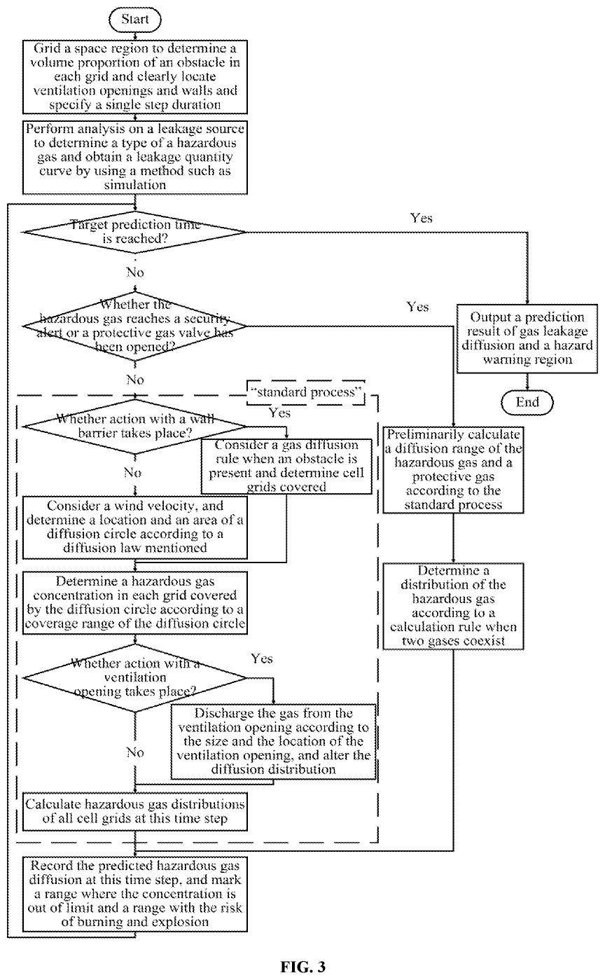

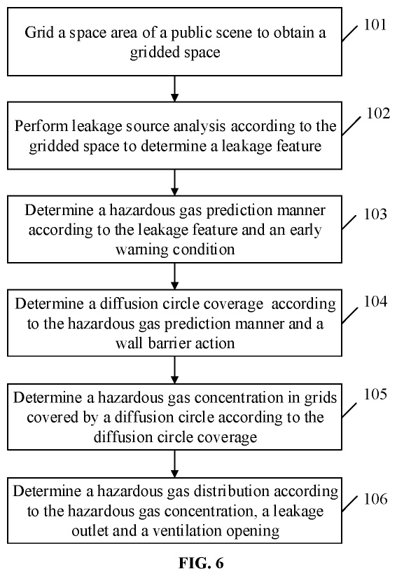

As shown in FIG. 3 and FIG. 6, a method for predicting a diffusion range of a hazardous gas provided in the present disclosure includes the following steps 101-106.

In step 101, a space area of a public scene is gridded to obtain a gridded space.

The space area is gridded to determine a free air volume in each grid and to specify a ventilation opening, a wall and a single-step duration, as shown in a formula (1).

In step 102, leakage source analysis is performed according to the gridded space to determine a leakage feature.

The leakage source is analyzed to determine a type of the hazardous gas, and a leakage ratecurve is obtained by using a simulation method.

In step 103, a hazardous gas prediction manner is determined according to the leakage feature and an early warning condition. The hazardous gas prediction manner includes a hazardous gas existence mode and a protective gas coexistence mode.

Step 103 specifically includes: determining whether the public scene meets the early warning condition to obtain a first determination result, where the early warning condition is that the hazardous gas reaches a security alert or a protective gas valve has been turned on. If the first determination result is yes, the hazardous gas prediction manner is determined to be a protective gas coexistence mode; and the diffusion range of the hazardous gas and the protective gas is preliminarily calculated according to a standard process. A distribution of the hazardous gas is determined according to a calculation rule when two gases coexist. If the first determination result is no, the hazardous gas prediction manner is determined to be a hazardous gas existence mode.

Before determining whether the public scene meets the early warning condition, whether target prediction time is reached is determined. If not, whether the public scene meets the early warning condition is determined; and if yes, a prediction result of gas leakage diffusion and a hazard warning area are output.

In step 104, a diffusion circle coverage is determined according to the hazardous gas prediction manner and a wall barrier action.

Step 104 specifically includes: determining whether an action with a wall barrier takes place to obtain a second determination result. If the second determination result is yes, the diffusion circle coverage is determined according to the hazardous gas existence mode of the hazardous gas prediction manner and a gas diffusion rule with a barrier; and if the second determination result is no, the diffusion circle coverage is determined according to the hazardous gas existence mode in the hazardous gas prediction manner, a wind velocity, and the gas diffusion rule without a barrier. The calculation of the diffusion circle coverage formed by a hazardous gas cloud cluster involves calculating a spatial location of the diffusion circle and a radius and a thickness of the hazardous gas cloud cluster, as shown in formulas (2), (3), (4), (5), (7) and (8).

In step 105, a hazardous gas concentration for a diffusion circle formed by each hazardous gas cloud cluster is determined according to the diffusion circle coverage, as shown in a formula (6).

In step 106, a hazardous gas distribution is determined according to the hazardous gas concentration, a leakage opening and the ventilation opening.

Step 106 specifically includes: determining whether an action with the ventilation opening takes place to obtain a third determination result. If the third determination result is yes, the hazardous gas distribution is determined according to a size and a location of the ventilation opening, the hazardous gas concentration and the leakage opening; and if the third determination result is no, the hazardous gas distribution is determined according to the hazardous gas concentration and the leakage opening. In combination with all diffusion circle coverage, hazardous gas distributions of all grids at a time step are calculated, as shown in a formula (6). The prediction of the hazardous gas diffusion at this time step is recorded, and a concentration exceeding range and a burning and explosion risk range are marked. When the protective gas is present, the hazardous gas concentration and an oxygen concentration in the grid need to be corrected according to a formula (9).

An objective of embodiments of the present disclosure is to provide a method for predicting the hazardous gas (e.g., hydrogen) diffusion in a windy public place (e.g., a factory building), so as to realize real-time prediction of the gas diffusion area in the public place and marking of a hazardous range. Moreover, an operation strategy of a hazardous gas treatment facility (protective gas release) is also proposed.

A first step is preprocessing of a hazardous gas leakage source and a scene

For a certain public scene containing a hazardous gas pipeline, its leakage features, i.e., a type of the hazardous gas, a state of the leakage source and a leakage flow rate curve, should be determined firstly. Hazardous gases may be roughly divided into three types according to their density relationships with air: a low density gas, a medium density gas and a high density gas. For the medium density gas close to the air in density, a spherical model is adopted in subsequent diffusion prediction, and for the low density gas and the high density gas, the diffusion prediction thereof may be simplified, which will be described in detail below: The leakage flow rate curve may be obtained in real time by using a flow sensor and used to calculate the diffusion. To achieve the purpose of the prediction, a flow rate change curve during leakage may be simulated in advance through a leakage experiment and a CFD model simulation, so as to realize specific prediction and protection for the leakage. The state of the leakage source may includes a leakage location, a leakage direction, an initial velocity, etc., values of which may be selected according to the actual situation of the hazardous gas pipeline.

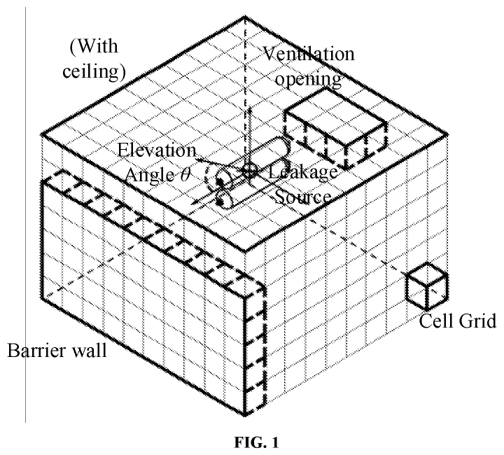

The public scene is processed as follows. The scene is divided into a number of cubic cell grids. It is recommended to set each cell grid as a cube to simplify the calculation. However, the side lengths of the cell grids at different positions may be freely adjusted to meet the requirement of intensively monitoring a specific area. Subsequently, a proportion of barriers in each cell grid is estimated and a free air volume in the cell grid is calculated. According to positions of a wall and a ventilation opening in the wall in the public place, the cell grids adjacent to the wall and the ventilation opening are marked separately. In this step, a total prediction time and a time step length should also be determined in order to determine the accuracy and time range of the prediction of hazardous gas leakage and diffusion. The free air volume is an overall volume of air in the scene excluding barriers. The free air volume is calculated as follows:

$${V}_{f} = {L}_{a} \times {L}_{b} \times {L}_{h} ( 1 - {k}_{V} ) , \qquad ( 1 )$$

where V_{f} represents a free air volume in a cell grid: Lₐ, L_{b}, and Lₖ represent a length, a width and a height of the cell grid, respectively; and kₗ, represents a barrier ratio of the cell grid, i.e., a volume fraction occupied by barriers. The schematic diagram of the preprocessing of the hazardous gas leakage source and the scene is as shown in FIG. 1.

A second step is to perform stepwise prediction calculation on the diffusion of the hazardous gas according to an initial setting

For the low density gas or high density gas, the diffusion thereof is simplified to a certain extent such that radial diffusion is decoupled from the longitudinal diffusion caused by buoyancy. The radial diffusion in a windless condition is generally isotropic, so the leaked hazardous gas tends to form a circular hazardous gas cloud cluster, which is also referred to as a diffusion circle (the gas cloud cluster of a medium density gas is spherical, and there is only one formula for calculating its diffusion size). According to the gas diffusion rule, a rate of the radial diffusion is related to a concentration of a hazardous gas cloud cluster at the current time step, which may be simply written as:

$${R}_{t + 1} = {R}_{t} + {m}_{k , R} {K}_{t} T , \qquad ( 2 )$$

A thickness change of the hazardous gas cloud cluster caused by the longitudinal diffusion may be similarly expressed as:

$${H}_{t - 1} = {H}_{t} + 2 {m}_{k , H} {K}_{t} T , \qquad ( 3 )$$

where Rₜ₊₁ and Rₜ represent radii of the hazardous gas cloud cluster in (t+1)th and (t)th time steps, and Hₜ₋₁ and Hₜ represent thicknesses of the hazardous gas cloud cluster in the (t+1)th and (t)th time steps, and initial values of the above physical quantities are all zero: Kₜ represents an average percent concentration of the hazardous gas cloud cluster in the (t)th time step; T represents a length of a time step: M_{k,R} and m_{k,H} represent radial and longitudinal diffusion proportional coefficients, respectively; m_{k,H} should be less than m_{k,R}; and the coefficients for different types of gases are different. A medium density gas only involves radial diffusion. A gas cloud cluster concentration at a first time step may be calculated in a slightly different mode. When a gas flow rate is excessively large, a gas cloud concentration in the first time step calculated according to the first formula of formula (6) may exceed 100%, which indicates that the diffusion law cannot be applied normally due to the accumulation of the hazardous gas at a leakage outlet. In this case, the shape of the gas cloud cluster should be expanded proportionally until the gas cloud concentration is equal to 100%.

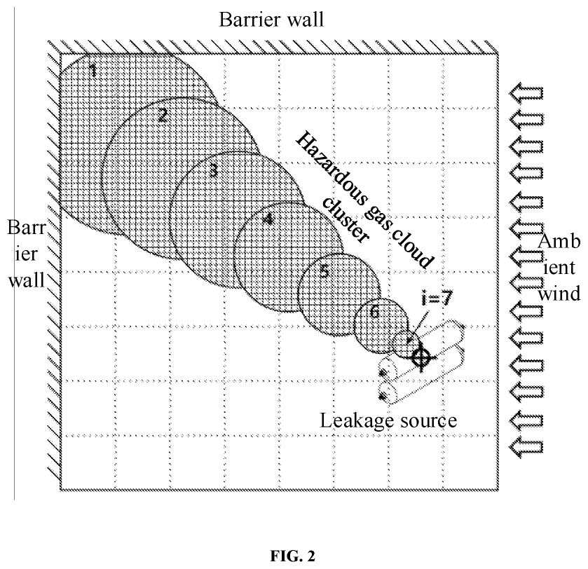

In a windy state, the position of the hazardous gas cloud cluster at a certain time is jointly determined by a leakage source position, a leakage direction, an initial leakage velocity, a wind direction and a wind velocity. It is approximately considered that the hazardous gas cloud cluster always remains circular during the diffusion, and coordinates of the center of the diffusion circle formed by the hazardous gas cloud cluster are as follows:

$${\vec{X}}_{t + 1} = {\vec{X}}_{t} + ( {U}_{t} {\vec{e}}^{x} + {\vec{w}}_{t} ) T , \qquad ( 4 )$$

where X̅ₜ₋₁ represents a position vector of the center of the diffusion circle relative to a leakage source in the (t+1)th time step: X̅ₜ represents a position vector (in the horizontal plane) of the center of the diffusion circle in the (t)th time step, initial values of the above physical quantities are all zero; ē^{x} represents a projection vector of a vector in a leakage direction on the horizontal plane; U: represents an initial leakage velocity in the (t)th time step; and w̅ₜ represents a wind velocity vector. If the diffusion circle intersects a wall surface, the portion outside the wall surface may be cut out directly to simulate the accumulation of the hazardous gas caused by the wall obstruction. The diffusion circle formed by the hazardous gas cloud cluster is as shown in FIG. 2.

For a longitudinal position of the hazardous gas cloud cluster, the joint influence of an initial velocity of a jet and the buoyancy should be considered. If the wind direction has a longitudinal component, the longitudinal component also needs to be considered (unusual). The longitudinal position of diffusion of the hazardous gas cloud cluster may be expressed as:

$$\{ \begin{matrix}{Y}_{t} {\text{?}}_{1} = {Y}_{t} + \frac{{U}_{t} + {U}_{t} {\text{?}}_{1}}{2} T \\ {U}_{t}^{Y} {\text{?}}_{1} = {U}_{t}^{Y} + \frac{( {ρ}_{A} {\text{?}}_{r} - {ρ}_{w} ) {Q}_{t} {T}^{2} g}{( 1 - K \text{?} ) {ρ}_{A} {\text{?}}_{r} + K \text{?} {ρ}_{w}}\end{matrix} , \qquad ( 5 )$$

$$\text{?} \text{indicates text missing or illegible when filed}$$

where Yₜ₋₁ and represent a longitudinal position and a longitudinal velocity of the hazardous gas cloud cluster relative to a leakage source in the (t+1)th time step, respectively; Yₜ and Uₜ^{Y} represent a longitudinal position and a longitudinal velocity of the hazardous gas cloud cluster in the (t)th time step, respectively, the longitudinal velocity has an initial value U₀ sin θ; θ represents an elevation angle of a leakage direction; an initial value of the longitudinal position is zero; ρ_{Air} represents an ambient air density; β_{w} represents a hazardous gas density (which is quite different from the air density); g represents a local gravity acceleration; and Uₜ₋₁ represents an initial leakage velocity in the (t+1)th time step.

As shown in FIG. 2, a leakage source generates one hazardous gas cloud cluster per time step. A state of the gas cloud cluster in a previous time step can be used to calculate a state of the gas cloud cluster in the next time step. A hazardous gas concentration of each cloud cluster should be calculated firstly, and then according to a size and a position of a diffusion circle formed by the cloud cluster, a pollution (coverage) coefficient of each cell grid covered by the diffusion circle may be further identified. To simplify the calculation, when counting the polluted cell grids, the degree of pollution is divided into four levels. When diffusion circle coverage is approximate to ¼ of the cell grid range, the degree of pollution is light pollution with a pollution (coverage) coefficient of 0.25, and when a coverage range is approximate to 2/4 (¾, 4/4) of a cell grid, the degree of pollution is medium (severe, complete) pollution with a pollution coefficient of 0.50 (0.75, 1.00). In actual calculation, a coverage degree of each cell grid may be calculated directly according to a volume ratio, or calculated in the top view plane and the height direction respectively to obtain the pollution coefficients and then multiply the pollution coefficients. A concentration in a same cloud cluster is considered to be uniformly distributed, and its concentration value is obtained by dividing the hazardous gas content by a total free air volume covered. When there are multiple cloud clusters coexist on the field at the same time and they overlap with each another, a hazardous gas concentration in each grid is a sum of concentrations of all hazardous gas cloud clusters in the cell grid. The hazardous gas concentration in each cell grid is calculated by the following formula:

$$\{ \begin{matrix}K \text{?} = \frac{{Q}_{t} T}{{{\sum }^{n}}_{j = 1} \text{?} {V}_{f}^{i}} \\ {K}_{t}^{j , sum} = {{\sum }^{N}}_{j = 1} {E}^{j} {l}_{t}^{i , j} {K}^{i} \text{?}\end{matrix} \qquad ( 6 )$$

$$\text{?} \text{indicates text missing or illegible when filed}$$

where Kₜ^{j,sum} represents a total concentration of the hazardous gas in the (j)th cell grid; Kₜⁱ represents an average concentration in the (i)th gas cloud cluster; Q represents a leakage volume flow rate of the hazardous gas from the leakage source at the (t)th time step; lₜ^{i,j} represents a pollution (coverage) coefficient of the (i)th gas cloud cluster with respect to the (j)th cell grid, a value of which is determined as described above. E^{j} represents a ventilation opening determination coefficient. If the (j)th cell grid is a cell grid adjacent to the ventilation opening (which has been confirmed in the first step), the coefficient is 0, which means that the hazardous gas escapes from the ventilation opening into the external space. V_{f}ⁱ represents a free air volume in the (i)th gas cloud cluster; and n represents a total number of cell grids covered by the (i)th gas cloud cluster.

A third step is to make an improvement on the prediction of concentration distribution when there is a protective gas

A prediction result of the hazardous gas distribution in any time step may be obtained according to the above steps. The result is recorded, and a parameter of this time step is used to iteratively calculate a gas distribution in the next time step. The above steps are repeated until the prediction time reaches a desired value, thereby completing the prediction of the hazardous gas diffusion. After each time step iteration, based on a hazardous gas concentration threshold set according to actual demands, the number and positions of cell grids containing gas clouds exceeding the concentration threshold are counted. These cell grids together form a range of a hazardous range, and the size and range information of the hazardous area is sent to an operating system and personnel for timely alarm and timely disposal.

Once a predicted hazardous gas indicator (a leakage quantity, a hazardous range volume, etc.) reaches a security alert value, a protective gas pipeline is activated immediately, and nitrogen is used to fill the space region to slow down the accumulation of the hazardous gas. For the nitrogen as the medium density gas, its diffusion range may be considered as a sphere, and a spherical center position and a radius of the protective gas cloud cluster may still be calculated by a method for calculating a radius and a position of the hazardous gas cloud cluster. It is also considered that the protective gas pipeline generates one protective gas cloud cluster per time step, and a state of the protective gas cloud cluster is iterated according to the time step. Since the medium density gas is close to air in density, an acceleration caused by the buoyancy needs not to be considered in the longitudinal direction, and only the influence of its initial velocity needs to be considered. A simplified formula for calculating the longitudinal position is as follows:

$${Y}_{t} {\text{?}}_{1} = {Y}_{t} + {U}_{0}^{Y} T , \qquad ( 7 )$$

$$\text{?} \text{indicates text missing or illegible when filed}$$

where U₀^{Y} represents an initial longitudinal velocity of the gas cloud cluster. A planar position of the protective gas cloud cluster is calculated in a same way as that of the hazardous gas, and due to spherical diffusion of the protective gas, only one formula is used to calculate a size of the protective gas cloud cluster:

$${R}_{t + 1} = {R}_{t} + {m}_{k , R} {K}_{t} T , \qquad ( 8 )$$

A concentration calculation formula of the protective gas is the same as that of high and small density hazardous gases, which will not be repeated here. It should be noted that since the protective gas (nitrogen) is a medium density gas in nature, a calculation process of a gas cloud cluster of the medium density hazardous gas is consistent with that of the protective gas.

Because of coexistence of the hazardous gas and the protective gas, the concentration calculation of the hazardous gas in a cell grid is slightly different from that when only the hazardous gas is present. After the protective gas is added, the protective gas will occupy the area where the hazardous gas and the air are mixed previously, so that the hazardous gas concentration in the cell grid is reduced. Moreover, for a flammable gas, since the air concentration is also reduced, a oxygen content is reduced, thus reducing the risk of gas ignition. In this case, the hazardous gas concentration and the oxygen concentration in the cell grid may be calculated by the following formula:

$$\{ \begin{matrix}{K}_{t}^{j , ptt} = {K}_{t}^{j , sum} ( 1 - {A}_{t}^{j , sum} ) \\ {O}_{t}^{j} = 0.2095 ( 1 - {K}_{t}^{j , ptt} ) ( 1 - {A}_{t}^{j , sum} )\end{matrix} , \qquad ( 9 )$$

where Kₜ^{Aptt} represents a total concentration of the hazardous gas in the (j)th cell grid after the protective gas is filled; Aₜ^{jsum} represents a total concentration of the protective gas in the (j)th cell grid; and Oₜ^{j} represents an oxygen content in the (j)th cell grid after the protective gas is filled. Thus, the hazardous gas distribution in each cell grid at any time may be calculated, and the range of the hazardous range at this time may be counted. The flowchart of the present disclosure is as shown in FIG. 3.

A windy hydrogen-related workplace is taken as an example. The hazardous gas is hydrogen, which belongs to a low density gas. The scene is simplified as a 5 m×5 m×5 m cuboid space, which is divided into cubic cell grids with a side length of 25 cm. There are no barriers or wall surfaces in all cell grids. Leakage is regarded as a steady leakage. A leakage flow rate is 300 SLPM(0.005 m³/s). A leakage direction is perpendicular to a cuboid space surface. An initial velocity of the jet is 0.5 m/s. A wind velocity is perpendicular to the initial velocity of the jet, and a value of the wind velocity is also 0.5 m/S. The positions of the hazardous gas leakage source and the protective gas release outlet are marked in the figures. The time step is set as 1 s, and the total prediction time is 5 s.

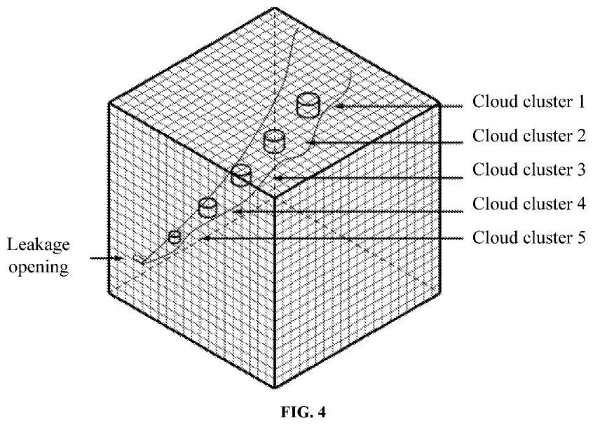

m_{k,R} is set as 0.12, and m_{k,H} is set as a relatively smaller value, namely 0.08. By calculation, in the first second, the leaked hydrogen diffuses into a gas cloud cluster with a volume of about 7 L in this second, and the prediction of the hydrogen distribution after five seconds is as shown in FIG. 4. According to the steps described above, a hazardous concentration threshold of the hydrogen is set to 4%, and a range of cell grids with the concentration exceeding the standard is determined, from which cell grids with the oxygen content exceeding 10% are then found out and marked as cell grids with explosion risk. The numbers of the two types of cell grids are as shown in Table 1.

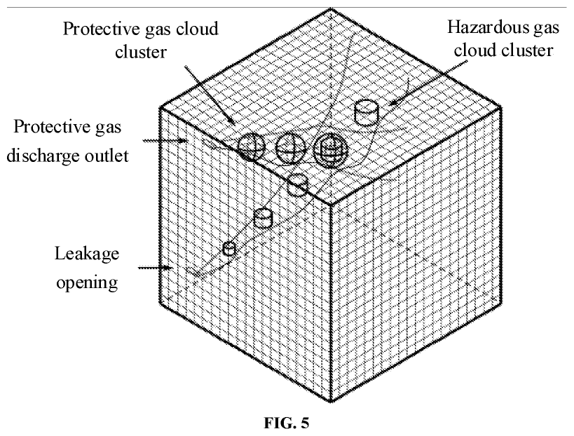

In addition, a calculation is also made for a case with a protective measure. When the number of cell grids with the hydrogen concentration exceeding the standard is more than 2, a protective gas (nitrogen) valve is turned on to discharge nitrogen into the space. Since the diffusion ability of nitrogen is much less than that of hydrogen, m_{k,H} is set as 0.04. As can be seen from Table 1, in the 2nd second, the number of cell grids with the hydrogen concentration exceeding the standard is 2.75. The nitrogen valve is then turned on in the third second, and the positions and numbers of cell grids with the concentration exceeding the standard and cell grids with explosion risk in subsequent time steps are calculated according to steps shown in FIG. 3, as shown in FIG. 5 and the last two columns of Table 1. As can be seen, after the end of the prediction, i.e., after the fifth second, due to the intervention of the protective gas, the number of cell grids with the concentration reaching the threshold and the number of cell grids with explosion risk both are reduced.

TABLE 1
Prediction Results of Hydrogen Diffusion (in total 5 s)

| | Without Protective Gas | | | | With Protective Gas | |
|---|---|---|---|---|---|---|
| | Concentration | | | | Concentration | |
| | exceeding the | | Burning and | | exceeding the | Burning and |
| | standard | | Explosion Risk | | standard | Explosion Risk |
| 1^{st} Second | 0.75 | grid | 0.75 | grid | ″ | ″ |
| 2^{nd} Second | 2.75 | grids | 2.75 | grids | ″ | ″ |
| 3^{rd} Second | 5.25 | grids | 5.25 | grids | ″ | ″ |
| 4^{th} Second | 9.00 | grids | 9.00 | grids | 9.00 grids | 9.00 grids |
| 5^{th} Second | 13.50 | grids | 13.50 | grids | 9.75 grids | 9.75 grids |

The present disclosure further provides a system for predicting a diffusion range of a hazardous gas, which includes:
a gridding module configured to grid a space area of a public scene to obtain a gridded space;
a leakage source analyzing module configured to perform leakage source analysis according to the gridded space to determine a leakage feature;
a hazardous gas prediction manner determining module configured to determine a hazardous gas prediction manner according to the leakage feature and an early warning condition, where the hazardous gas prediction manner includes a hazardous gas existence mode and a protective gas coexistence mode;
a diffusion circle coverage range determining module configured to determine a diffusion circle coverage according to the hazardous gas prediction manner and a wall barrier action;
a hazardous gas concentration determining module configured to determine a hazardous gas concentration in grids covered by a diffusion circle according to the diffusion circle coverage; and
a gas distribution determining module configured to determine a hazardous gas distribution according to the hazardous gas concentration, a leakage outlet and a ventilation opening.

As an alternative embodiment, the hazardous gas prediction manner determining module specifically includes:
an early warning condition determining unit configured to determine whether the public scene meets the early warning condition to obtain a first determination result, where the early warning condition is that the hazardous gas reaches a security alert or a protective gas valve has been turned on;
a protective gas coexistence mode determining unit configured to, if the first determination result is yes, determine that the hazardous gas prediction manner is a protective gas coexistence mode; and
a hazardous gas existence mode determining unit configured to, if the first determination result is no, determine that the hazardous gas prediction manner is a hazardous gas existence mode.

As an alternative embodiment, the diffusion circle coverage determining module specifically includes:
a wall barrier action determining unit configured to determine whether an action with a wall barrier takes place to obtain a second determination result;
a first diffusion circle coverage determining unit configured to, if the second determination result is yes, determine the diffusion circle coverage according to the hazardous gas existence mode of the hazardous gas prediction manner and a gas diffusion rule with a barrier; and
a second diffusion circle coverage determining unit configured to, if the second determination result is no, determine the diffusion circle coverage according to the hazardous gas existence mode of the hazardous gas prediction manner, a wind velocity, and a gas diffusion rule without a barrier.

As an alternative embodiment, the distribution determining module specifically includes:
a ventilation opening action determining unit configured to determine whether an action with the ventilation opening takes place to obtain a third determination result;
a first distribution determining unit configured to, if the third determination result is yes, determine the hazardous gas distribution according to a size and a position of the ventilation opening, the hazardous gas concentration and the leakage outlet; and
a second distribution determining unit configured to, if the third determination result is no, determine the hazardous gas distribution according to the hazardous gas concentration and the leakage outlet.

The present disclosure further provides an electronic device, which includes:
one or more processors; and
a storage device storing one or more programs thereon;
where the one or more programs, when executed by the one or more processors, cause the one or more processors to implement the method according to any one of the above items.

The present disclosure further provides a storage medium storing a computer program thereon, where the computer program, implements the method according to any one of the above items.

For a place involving a hazardous gas such as a hydrogen production workshop plant and a hazardous gas storage warehouse, when the hazardous gas leaks accidentally, it is necessary to predict the gas diffusion in space, thereby providing guidance for the arrangement of a sensor and a protection system. In the present disclosure, the hazardous gas distribution is simulated according to the movement of the hazardous gas cloud cluster in space, the prediction process is advanced in the chronological order according to the time step iteration, and various gases with low, medium and high densities are matched, which has the advantages of simplicity, ease of use, and good applicability: Comprehensive consideration is taken in the present disclosure. Not only influencing factors such as the position of the leakage source, the velocity of the jet and direction and buoyancy, but also environmental conditions such as an ambient wind velocity and a barrier wall surface are taken into account. Moreover, when a protective gas apparatus is provided, the interaction of multiple gases is also included in the analysis, which is not considered in other diffusion prediction methods. In addition, in the present disclosure, by means of a strategy of dividing cell grids and time steps, the continuous movement and the shape change of the gas cloud cluster are discretized, which simplifies calculation steps as much as possible, and keeps the calculation amount at an easily achievable level.

The embodiments of the present specification are described in a progressive manner. Each embodiment focuses on the difference from other embodiments, and the same and similar parts between the embodiments may refer to each other. Since the system disclosed in an embodiment corresponds to the method disclosed in another embodiment, the description is relatively simple, and reference can be made to the method description.

In this specification, some specific embodiments are used for illustration of the principles and implementations of the present disclosure. The description of the foregoing embodiments is merely used to help understand the method of the present disclosure and the core ideas thereof. In addition, those of ordinary skill in the art can make various modifications in terms of specific implementations and the scope of application in accordance with the ideas of the present disclosure. In conclusion, the content of the specification shall not be construed as limitations to the present disclosure.

What is claimed is:

1. A method for predicting a diffusion range of a hazardous gas, comprising:
gridding a space area of a public scene to obtain a gridded space;
performing a leakage source analysis according to the gridded space to determine a leakage feature;
determining a hazardous gas prediction manner according to the leakage feature and an early warning condition, wherein the hazardous gas prediction manner includes a hazardous gas existence mode and a protective gas coexistence mode;
determining a diffusion circle coverage according to the hazardous gas prediction manner and a wall barrier action;
determining a hazardous gas concentration in grids covered by a diffusion circle according to the diffusion circle coverage; and
determining a hazardous gas distribution according to the hazardous gas concentration, a leakage outlet and a ventilation opening.

2. The method according to claim 1, wherein the determining a hazardous gas prediction manner according to the leakage feature and an early warning condition comprises:
determining whether the public scene meets the early warning condition to obtain a first determination result, wherein the early warning condition is that the hazardous gas reaches a security alert or a protective gas valve has been turned on;
if the first determination result is yes, determining that the hazardous gas prediction manner is the protective gas coexistence mode; and
if the first determination result is no, determining that the hazardous gas prediction manner is the hazardous gas existence mode.

3. The method according to claim 1, wherein the determining a diffusion circle coverage according to the hazardous gas prediction manner and a wall barrier action comprises:
determining whether an action with a wall barrier takes place to obtain a second determination result;
if the second determination result is yes, determining the diffusion circle coverage according to the hazardous gas existence mode of the hazardous gas prediction manner and a gas diffusion rule with a barrier; and
if the second determination result is no, determining the diffusion circle coverage according to the hazardous gas existence mode of the hazardous gas prediction manner, a wind velocity, and the gas diffusion rule without a barrier.

4. The method according to claim 1, wherein the determining a hazardous gas distribution according to the hazardous gas concentration, a leakage outlet and a ventilation opening comprises:
determining whether an action with the ventilation opening takes place to obtain a third determination result;
if the third determination result is yes, determining the hazardous gas distribution according to a size and a position of the ventilation opening, the hazardous gas concentration and the leakage outlet; and
if the third determination result is no, determining the hazardous gas distribution according to the hazardous gas concentration and the leakage outlet.

5. A system for predicting a diffusion range of a hazardous gas, comprising:
a gridding module configured to grid a space area of a public scene to obtain a gridded space;
a leakage source analyzing module configured to perform leakage source analysis according to the gridded space to determine a leakage feature;
a hazardous gas prediction manner determining module configured to determine a hazardous gas prediction manner according to the leakage feature and an early warning condition, wherein the hazardous gas prediction manner comprises a hazardous gas existence mode and a protective gas coexistence mode;
a diffusion circle coverage determining module configured to determine a diffusion circle coverage according to the hazardous gas prediction manner and a wall barrier action;
a hazardous gas concentration determining module configured to determine a hazardous gas concentration in grids covered by the diffusion circle according to the diffusion circle coverage; and
a gas distribution determining module configured to determine a hazardous gas distribution according to the hazardous gas concentration, a leakage outlet and a ventilation opening.

6. The system according to claim 5, wherein the hazardous gas prediction manner determining module comprises:
an early warning condition determining unit configured to determine whether the public scene meets the early warning condition to obtain a first determination result, wherein the early warning condition is that the hazardous gas reaches a security alert or a protective gas valve has been turned on;
a protective gas coexistence mode determining unit configured to, if the first determination result is yes, determine that the hazardous gas prediction manner is the protective gas coexistence mode; and
a hazardous gas existence mode determining unit configured to, if the first determination result is no, determine that the hazardous gas prediction manner is the hazardous gas existence mode.

7. The system according to claim 5, wherein the diffusion circle coverage determining module comprises:
a wall barrier action determining unit configured to determine whether an action with a wall barrier takes place to obtain a second determination result;
a first diffusion circle coverage determining unit configured to, if the second determination result is yes, determine the diffusion circle coverage according to the hazardous gas existence mode of the hazardous gas prediction manner and a gas diffusion rule with a barrier; and
a second diffusion circle coverage determining unit configured to, if the second determination result is no, determine the diffusion circle coverage according to the hazardous gas existence mode of the hazardous gas prediction manner, a wind velocity, and a gas diffusion rule without a barrier.

8. The system according to claim 5, wherein the distribution determining module comprises:
a ventilation opening action determining unit configured to determine whether an action with the ventilation opening takes place to obtain a third determination result;
a first distribution determining unit configured to, if the third determination result is yes, determine the hazardous gas distribution according to a size and a position of the ventilation opening, the hazardous gas concentration and the leakage outlet; and
a second distribution determining unit configured to, if the third determination result is no, determine the hazardous gas distribution according to the hazardous gas concentration and the leakage outlet.

9. An electronic device, comprising:
one or more processors; and
a storage device storing one or more programs thereon;
wherein the one or more programs, when executed by the one or more processors, cause the one or more processors for;
gridding a space area of a public scene to obtain a gridded space;
performing a leakage source analysis according to the gridded space to determine a leakage feature;
determining a hazardous gas prediction manner according to the leakage feature and an early warning condition, wherein the hazardous gas prediction manner includes a hazardous gas existence mode and a protective gas coexistence mode;
determining a diffusion circle coverage according to the hazardous gas prediction manner and a wall barrier action;
determining a hazardous gas concentration in grids covered by a diffusion circle according to the diffusion circle coverage; and
determining a hazardous gas distribution according to the hazardous gas concentration, a leakage outlet and a ventilation opening.

10. The device according to claim 9, wherein the determining a hazardous gas prediction manner according to the leakage feature and an early warning condition comprises:
determining whether the public scene meets the early warning condition to obtain a first determination result, wherein the early warning condition is that the hazardous gas reaches a security alert or a protective gas valve has been turned on;
if the first determination result is yes, determining that the hazardous gas prediction manner is the protective gas coexistence mode; and
if the first determination result is no, determining that the hazardous gas prediction manner is the hazardous gas existence mode.

11. The device according to claim 9, wherein the determining a diffusion circle coverage according to the hazardous gas prediction manner and a wall barrier action comprises:
determining whether an action with a wall barrier takes place to obtain a second determination result;
if the second determination result is yes, determining the diffusion circle coverage according to the hazardous gas existence mode of the hazardous gas prediction manner and a gas diffusion rule with a barrier; and
if the second determination result is no, determining the diffusion circle coverage according to the hazardous gas existence mode of the hazardous gas prediction manner, a wind velocity, and the gas diffusion rule without a barrier.

12. The device according to claim 9, wherein the determining a hazardous gas distribution according to the hazardous gas concentration, a leakage outlet and a ventilation opening comprises:
determining whether an action with the ventilation opening takes place to obtain a third determination result;
if the third determination result is yes, determining the hazardous gas distribution according to a size and a position of the ventilation opening, the hazardous gas concentration and the leakage outlet; and
if the third determination result is no, determining the hazardous gas distribution according to the hazardous gas concentration and the leakage outlet.

13. A non-transitory, computer readable medium having computer program instructions tangibly stored on the computer readable medium, wherein the computer readable instructions are executable by a processor to perform a method, the method comprising:
gridding a space area of a public scene to obtain a gridded space;
performing a leakage source analysis according to the gridded space to determine a leakage feature;
determining a hazardous gas prediction manner according to the leakage feature and an early warning condition, wherein the hazardous gas prediction manner comprises includes a hazardous gas existence mode and a protective gas coexistence mode;
determining a diffusion circle coverage according to the hazardous gas prediction manner and a wall barrier action;
determining a hazardous gas concentration in grids covered by a diffusion circle according to the diffusion circle coverage; and
determining a hazardous gas distribution according to the hazardous gas concentration, a leakage outlet and a ventilation opening.

14. The computer readable medium according to claim 13, wherein the determining a hazardous gas prediction manner according to the leakage feature and an early warning condition comprises:
determining whether the public scene meets the early warning condition to obtain a first determination result, wherein the early warning condition is that the hazardous gas reaches a security alert or a protective gas valve has been turned on;
if the first determination result is yes, determining that the hazardous gas prediction manner is the protective gas coexistence mode; and
if the first determination result is no, determining that the hazardous gas prediction manner is the hazardous gas existence mode.

15. The computer readable medium according to claim 13, wherein the determining a diffusion circle coverage according to the hazardous gas prediction manner and a wall barrier action comprises:
determining whether an action with a wall barrier takes place to obtain a second determination result;
if the second determination result is yes, determining the diffusion circle coverage according to the hazardous gas existence mode of the hazardous gas prediction manner and a gas diffusion rule with a barrier; and
if the second determination result is no, determining the diffusion circle coverage according to the hazardous gas existence mode of the hazardous gas prediction manner, a wind velocity, and the gas diffusion rule without a barrier.

16. The computer readable medium according to claim 13, wherein the determining a hazardous gas distribution according to the hazardous gas concentration, a leakage outlet and a ventilation opening comprises:
determining whether an action with the ventilation opening takes place to obtain a third determination result;
if the third determination result is yes, determining the hazardous gas distribution according to a size and a position of the ventilation opening, the hazardous gas concentration and the leakage outlet; and
if the third determination result is no, determining the hazardous gas distribution according to the hazardous gas concentration and the leakage outlet.
